(19) United States
(12) Patent Application Publication
(10) Pub. No.: US 2008/0197123 A1
(43) Pub. Date: Aug. 21, 2008

(54) NO-FROST REFRIGERATOR

(75) Inventors: ENZO RIVIS, Biandronno (IT); RAFAEL REJDYCH, Olawa (PL)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, Benton Harbor, MI (US)

(21) Appl. No.: 12/032,133

(22) Filed: Feb. 15, 2008

(30) Foreign Application Priority Data
Feb. 16, 2007 (IT) VA/2007/U/00010

(51) Int. Cl. H05B 1/00; F25D 11/00

(52) U.S. Cl. 219/385; 62/440

(57) ABSTRACT

The present invention describes a no-frost refrigerator device capable of preventing the formation of ice on the upper wall of the refrigerator itself.

### BACKGROUND OF THE INVENTION

1. Field of the Invention

The field of the present invention is a device capable of preventing the formation of ice on the upper wall (top) of a refrigerator compartment, cooled by means of forced cold air. The term refrigerator should be understood here to mean any household appliance used for preserving foodstuffs, including refrigerator compartments for preserving fresh foods, both compartments for preserving frozen and/or deep frozen foodstuffs (freezers). The refrigerators cooled by forced air are commonly known as “no frost” refrigerators.

2. Description of the Related Art

There are solutions known in the art suitable for preventing the formation of condensate in traditional refrigerators, defined as “static”, produced by extending the capillary tube coming from the condenser, and integrating it inside the structure of the refrigerator. The capillary is positioned on the outer side of the upper wall of the refrigerator compartment (“liner”), normally made of plastic material, and embedded in the insulating material. The heat introduced by the capillary of the condenser heats the upper wall of the refrigerator, preventing the formation of condensate on it.

These solutions are not easy to apply to “no frost” refrigerators since, in these types of refrigerators the capillary is in a defined area of the refrigerator, because the evaporator is more compact and is located in a specific area, unlike a traditional refrigerator. In a traditional refrigerator the evaporator is normally positioned on the bottom wall of the compartment, so as to distribute the cold uniformly inside the compartment. Consequently the capillary of a traditional refrigerator is not restricted to one position, but can also branch out over the upper parts of the refrigerator, where the evaporator is usually placed.

The problem of condensate and of any accumulation of ice is particularly pronounced in compartments for preserving fresh foodstuffs (0° C. to 4° C.) that have a freezer compartment located over them, in which freezer compartment the temperature is on average −18° C. In this case the insulation between the two superimposed compartments may not be sufficient to guarantee a temperature at the ceiling capable of preventing ice formation.

The same problem is noticeable in refrigerators known as “dual-temperature”, in which structures the refrigerator compartment is above the freezer compartment.

The aforementioned problem is solved by the present invention thanks to the characteristics listed in the attached claims.

### BRIEF DESCRIPTION OF THE DRAWINGS

Further advantages and characteristics of the present invention will become obvious from the following detailed description supplied by way of example, with reference to the enclosed drawings in which:

FIG. 1 is a perspective view that illustrates a refrigerator compartment (“liner”) provided with a resistor according to the invention, and

FIG. 2 is a perspective view similar to FIG. 1 that illustrates a variant according to the invention.

### SUMMARY OF THE INVENTION

The present invention includes a domestic refrigerator that is cooled by forced air and has at least one compartment which is substantially parallelepipedal in shape, including an opening and an upper wall has an wherein an electrical heating element capable of limiting ice formation, located in close proximity to the upper wall. This heating element may be arranged uniformly over the upper wall or more densely in certain areas. It may be preferred to ensure a uniform temperature over the ceiling. For example, it may be advantageous of arranged the heater more densely about the opening or about an air duct into the compartment. The heater can also be positioned as so the user cannot see it.

### DETAILED DESCRIPTION OF THE PREFERRED EMBODIMENTS

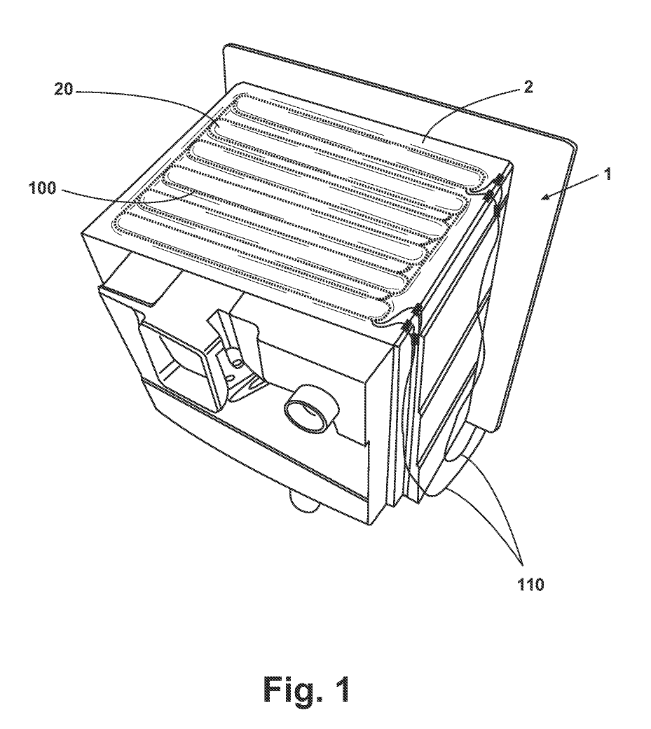

With reference to FIG. 1, on the upper portion of the covering of the compartment 1 (“liner”), which defines a storage space for a “no frost” refrigerator, a linear resistor 100 is placed in contact with the outer upper face 2 of said “liner” 1, before the application of the insulating material, for example polyurethane. The resistor 100 is fixed to the “liner” 1, preferably by means of adhesive material 20, for example aluminium adhesive tape. In this embodiment the resistor 100 is arranged as a coil, positioned uniformly over the whole surface of the upper face 2 of the “liner” 1. The supply terminals 110 to the electrical resistor extend towards the lower area of the compartment, where there is electrical supply for the resistor. In this embodiment a common linear resistor has been used, approximately 2.5 m long, which dissipates a total power of 6 watts with a 230 V supply.

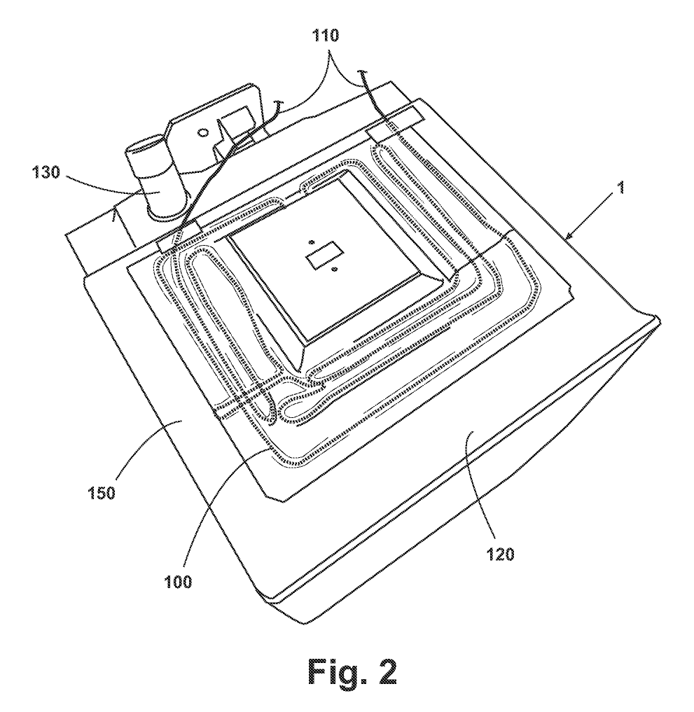

FIG. 2 illustrates a second variant relative to the type of arrangement of the linear resistor 100, arranged more densely in the areas near the front 120 and side 150 edges of the outer upper face 2 of the compartment 1, i.e. substantially close to the door of the refrigerator and in the area 130 where cold air is introduced into the cavity of the refrigerator.

It is stated that, as an alternative to the linear type of resistors, non-linear resistors can be used, which can dissipate heat in a differentiated manner, with the aim of achieving uniform heating.

Also in this second variant a linear resistor has been used, with a uniform resistance, approximately 2.5 m long. The power dissipated from this second resistor is approximately 4 W at 230 V. Suitable wiring connects the resistor to the power supply terminals of the refrigerator.

Once the construction of the “no frost” refrigerator is finished, the resistor 100 is no longer visible, since it is incorporated into the insulating foam.

The resistor 100 is activated at least at the same time as the introduction of cold air into the compartment. When the resistor 100 is activated, it heats the ceiling of the refrigerator compartment, preventing the formation of ice thereon. From experiments conducted it is shown that the most effective distribution of the resistor is the one that causes uniform distribution of heat over the ceiling of the “no frost” refrigerator, near to which the cold cooling air is introduced.

Finally, it may be noted that, still with the aim of preventing the formation of ice on the ceiling of the refrigerator compartment, it may become necessary to heat the ceiling of the compartment non-uniformly, either near the cold air outlet, or near the door opening.

As concerns the procedure for activating the resistor 100, it is also possible to keep the resistor continuously activated, or to execute operating cycles, modulating the introduction of heat.

The solution according to the invention therefore prevents the formation of ice inside a refrigerator with forced air circulation, which it would oblige the user to carry out frequent defrosting operations capable of restoring full functionality to the “no frost” refrigerator.

We claim:

1. A domestic refrigerator cooled with forced air comprising:
at least one refrigerator compartment substantially parallelepipedal in shape with an opening and an upper wall wherein the upper wall further comprises
an electrical heating element wherein
the electrical heating element is capable of limiting ice formation, and
the electrical heating element is located in close proximity to the upper wall.

2. The refrigerator according to claim 1, further wherein the electrical heating element is arranged uniformly over the upper wall.

3. The refrigerator according to claim 1, wherein the electrical heating element is arranged non-uniformly over the upper wall.

4. The refrigerator according to claim 1, wherein the electrical heating element generates a uniform temperature over the ceiling of the refrigerator.

5. The refrigerator according to claim 1, wherein the electrical heating element is not visible to the user.

6. The refrigerator according to claim 1, comprising a freezer compartment cooled to a temperature below that of the refrigerator compartment, wherein the refrigerator compartment is below the freezer compartment.

7. A refrigerator comprising:
a fresh food compartment wherein:
the fresh food compartment is cooled to a temperature above 0° C.,
the fresh food compartment is defined on a plurality of sides by a fresh food liner,
the liner comprising:
walls, the walls further comprising:
an inner side and an outer side, and
a top wall;
an electrical heater wherein:
the electrical heater is at the top wall of the fresh food compartment, and
the resistive heater is capable of limiting ice formation.

8. The refrigerator according to claim 7, further comprising:
at least one fresh food air duct defining an opening through the liner and wherein the fresh food air duct introduces cold air into the fresh food compartment for cooling the fresh food compartment, and
wherein the electrical heater is arranged to provide additional heat about the area adjacent to the at least one fresh food air duct.

9. The refrigerator according to claim 8, further comprising:
two side walls, the side walls substantially perpendicular to the top wall and substantially parallel to each other,
a rear wall, substantially perpendicular to the top and side walls, and
an opening to the fresh food compartment; and
wherein the electrical heater is arranged to provide additional heat about the area adjacent to the opening.

10. The refrigerator according to claim 7, further comprising:
an opening to the fresh food compartment; and
wherein the electrical heater is arranged to provide additional heat about the area adjacent to the opening.

11. The refrigerator according to claim 7, wherein the electrical heater is affixed to the outer side of the fresh food liner.

12. The refrigerator according to claim 11, wherein the heater is affixed to the outer side of the fresh food liner by aluminium adhesive tape.

13. The refrigerator according to claim 7, wherein the electrical heater is continuously activated.

14. A refrigerator comprising:
a freezer compartment wherein the freezer compartment is cooled by air to temperature below 0° C.;
a fresh food compartment wherein:
the fresh food compartment is cooled by air to a temperature above 0° C.,
the fresh food compartment is positioned below the freezer compartment, and
the fresh food compartment is defined by a liner, the liner comprising;
walls, each wall having an inner side and an outer side, the walls further comprising:
two side walls, the side walls substantially perpendicular to the top wall and substantially parallel to each other, and
a rear wall, substantially perpendicular to the top and side walls; and
an opening to the fresh food compartment;
and at least one fresh food air duct defining an opening through the liner and wherein the fresh food air duct introduces cold air into the fresh food compartment for cooling the fresh food compartment, and
a resistive heater wherein:
the electrical heater is capable producing heat to limit ice formation.

15. The refrigerator according to claim 14, wherein the resistive heater is cycled on and off.

16. The refrigerator according to claim 14, wherein the resistive heater is arranged as to provide a substantially uniform temperature throughout the top wall.

17. The refrigerator according to claim 16, wherein the resistive heater is arranged as to provide a substantially uniform temperature by arranging a denser portion of the resistive heater about the fresh food air duct.

18. The refrigerator according to claim 17, wherein the resistive heater is arranged as to provide a substantially uniform temperature by arranging a denser portion of the resistive heater is arranged about the opening.

19. The refrigerator according to claim 16, wherein the resistive heater is arranged as to provide a substantially uniform temperature by arranging a denser portion of the resistive heater is arranged about the opening.

20. The refrigerator according to claim 14, wherein a denser portion of the resistive heater is arranged about the opening.
